(19) United States
(12) Patent Application Publication
(10) Pub. No.: US 2011/0309974 A1
(43) Pub. Date: Dec. 22, 2011

(54) ANNIHILATION METHOD FOR GPS INTEGER AMBIGUITY WITH RESIDUAL PROBABILITY SCORING

(75) Inventor: Walton R. Williamson, Pasadena, CA (US)

(73) Assignee: California Institute of Technology, Pasadena, CA (US)

(21) Appl. No.: 13/161,458

(22) Filed: Jun. 15, 2011

Related U.S. Application Data
(60) Provisional application No. 61/355,043, filed on Jun. 15, 2010.

(51) Int. Cl. G01S 19/41; G01S 19/32

(52) U.S. Cl. 342/357.24; 342/357.72

(57) ABSTRACT

A method of locating a first GPS receiver relative to a second GPS receiver. The method includes the steps of: providing a first and second GPS receiver, the first and second GPS receiver spaced apart by a distance D along a baseline; receiving a finite number of observables from a plurality of GPS satellites in a finite period of time; performing in a batch mode the following series of calculations on the finite number of observables: calculating a least squares estimate position for each of the first GPS receiver and the second GPS receiver; calculating a plurality of single difference residuals; calculating a plurality of double difference residuals; calculating an estimate of a geometry free solution; applying geometric annihilation to the geometry free solution; and calculating a least squares solution to provide a measurement of the distance D. A batch processing mode differential GPS apparatus is also described.

### CROSS-REFERENCE TO RELATED APPLICATIONS

This application claims priority to and the benefit of co-pending U.S. provisional patent application Ser. No. 61/355,043, Annihilation method for GPS integer ambiguity with residual probability scoring, filed Jun. 15, 2010, which application is incorporated herein by reference in its entirety.

### STATEMENT REGARDING FEDERALLY FUNDED RESEARCH OR DEVELOPMENT

The invention described herein was made in the performance of work under a NASA contract, and is subject to the provisions of Public Law 96-517 (35 USC 202) in which the Contractor has elected to retain title.

### FIELD OF THE INVENTION

The invention relates to GPS in general and more particularly to a differential GPS method.

### BACKGROUND OF THE INVENTION

The accuracy of GPS distance and position determinations is generally dependent on the number of satellites of the GPS constellation that are successfully received at any given time. For a number of reasons, a number of the satellites that might otherwise be in view at any given time can be blocked. Particularly in mobile applications, there can be times when the number of received satellites can drop to four or less due to GPS blockage along a route. Breaks in a GPS solution due to blockage causes errors in the calculated position. Such errors can be on the order of one to several meters.

Using distance and position computation methods of the prior art, satellite blockage causes a range of difficulties. At one extreme a solution might never successfully converge under some blockage situations having certain error bounds or limits in the calculations. A more common situation is a prior art algorithm which restarts one or more times during changing blocking situations. The restarting causes previously received GPS observations to be lost during the restart process. Moreover, when blockage situations end, prior art solutions have difficulty (which is observed as a delay) in evaluating how to factor the GPS observables from one or more newly appeared satellites into an instant distance or position calculation.

There is a need for a method to reduce position errors caused by GPS satellite blockage.

### SUMMARY OF THE INVENTION

According to one aspect, the invention features a method of locating a first GPS receiver relative to a second GPS receiver, including the steps of: providing a first GPS receiver and a second GPS receiver, each GPS receiver having its own GPS antenna, the first GPS receiver and the second GPS receiver spaced apart by a distance D along a baseline, the distance D to be determined; receiving a finite number of observables on each of the first GPS receiver and the second GPS receiver from a plurality of GPS satellites in a finite period of time; performing in a batch mode the following series of calculations on the finite number of observables: calculating a least squares estimate position for each of the first GPS receiver and the second GPS receiver; calculating a plurality of single difference residuals based on the observables; calculating a plurality of double difference residuals based on the plurality of single difference residuals; calculating an estimate of a geometry free solution; applying geometric annihilation to the geometry free solution; and calculating a least squares solution to provide a measurement of the distance D; and performing a step selected from the steps consisting of recording the distance D, reporting the distance D to a user, and providing the distance D to another process that uses the distance D.

In one embodiment, the step of calculating a least squares solution includes an absolute position of at least one of the first GPS receiver and the second GPS receiver relative to the plurality of GPS satellites.

In another embodiment, the step of receiving observables includes receiving a plurality of GPS L1, P1 and GPS L2, P2 data.

In yet another embodiment, the step of receiving observables further includes computing at least one combination selected from the group of combinations consisting of a PC combination, a LC combination, a LWL combination, and a PNL combination from the plurality of L1, P1 and L2, P2 data.

In yet another embodiment, the step of receiving observables includes receiving observables in a GPS RINEX format.

In yet another embodiment, the method further includes, after the step of receiving observables and before the step of calculating a least squares estimate position, a step of processing the residuals to remove outlying data which exceeds a bound value.

In yet another embodiment, the method further includes, after the step of receiving observables and before the step of calculating a least squares estimate position, a step of calculating corrections based on a measured or a modeled data of GPS radio propagation conditions of the Troposphere.

In yet another embodiment, the method further includes, calculating corrections using an annihilation technique with modeled data of GPS radio propagation conditions of the Troposphere.

In yet another embodiment, the step of calculating a plurality of single difference residuals includes forming the single differences from at least a selected one of a LWL combination, a PNL combination, and a PC combination.

In yet another embodiment, the step of calculating a plurality of double difference residuals includes forming the double differences from at least a selected one of a LWL combination, a PNL combination, and a PC combination.

In yet another embodiment, the step of calculating an estimate of a geometry free solution includes an estimate of a double difference ambiguity using a LWL−PWL combination.

In yet another embodiment, the step of calculating an estimate of a geometry free solution includes calculating an estimate and fix integer by averaging LWL−PNL over each arc length.

In yet another embodiment, the step of calculating an estimate of a geometry free solution includes filtering and removing LWL+fix−PNL outlier estimates greater than a bound value.

According to another aspect, the invention features a batch processing mode differential GPS apparatus which includes a data processor configured to receive a plurality of GPS observables observed over a fixed time period from each of a first GPS receiver and a second GPS receiver. Each GPS receiver has its own GPS antenna. The first GPS receiver and the second GPS receiver are spaced apart by a distance D, the distance D to be determined. The data processor has instructions in a machine-readable form recorded therein. The data processor is configured to perform a process including the steps of: receiving a finite number of observables on each of the first GPS receiver and the second GPS receiver from a plurality of GPS satellites in a finite period of time; performing in a batch mode the following series of calculations on the finite number of observables: calculating a least squares estimate position for each of the first GPS receiver and the second GPS receiver; calculating a plurality of single difference residuals based on the observables; calculating a plurality of double difference residuals based on the plurality of single difference residuals; calculating an estimate of a geometry free solution; applying geometric annihilation to the geometry free solution; and calculating a least squares solution to obtain a result including the distance D between the first GPS receiver and the second GPS receiver when the instructions are operating. At least one device is selected from the group of devices consisting of a recording device configured to record a distance result, a display device configured to display the distance result, and a communications device configured to provide the distance result to another device.

In one embodiment, the batch processing mode differential GPS apparatus is configured to perform the step of calculating a least squares solution which includes an absolute position of at least one of the first GPS receiver and the second GPS receiver relative to the plurality of GPS satellites.

In another embodiment, the batch processing mode differential GPS apparatus is configured to perform the step of perform the step of receiving observables by receiving a plurality of GPS L1, P1 and GPS L2, P2 data.

In yet another embodiment, the batch processing mode differential GPS apparatus is configured to perform the step of perform a step of computing at least one combination selected from the group of combinations consisting of a PC combination, a LC combination, a LWL combination, and a PNL combination from the plurality of L1, P1 and L2, P2 data.

In yet another embodiment, the batch processing mode differential GPS apparatus is configured to perform a step of processing the residuals to remove outlying data which exceeds a bound value after the step of receiving observables and before the step of calculating a least squares estimate position.

In yet another embodiment, the batch processing mode differential GPS apparatus is configured to perform a step of calculating corrections based on a measured or a modeled data of GPS radio propagation conditions of the Troposphere after the step of receiving observables and before the step of calculating a least squares estimate position.

In yet another embodiment, the batch processing mode differential GPS apparatus is configured to perform a step of calculating corrections using an annihilation technique with modeled data of GPS radio propagation conditions of the Troposphere.

The foregoing and other objects, aspects, features, and advantages of the invention will become more apparent from the following description and from the claims.

### BRIEF DESCRIPTION OF THE DRAWINGS

FIG. 1 shows a graph of the number of satellites received plotted against time which defines the satellite environment.

FIG. 2A shows a graph of range distance versus time for one exemplary test run.

FIG. 2B shows a graph of the GPS distance calculation for the same test run and time period of FIG. 2A.

FIG. 3 shows a block diagram of one generalized embodiment of a batch mode least squares differential GPS method according to principles of the invention.

FIG. 4 shows a block diagram of another embodiment of a batch mode least squares differential GPS method according to principles of the invention.

FIG. 5A shows a block diagram of the test setup at the ALURE laser transmitter of the laser range finder base station.

FIG. 5B shows a block diagram of the test setup on the truck.

FIG. 5C shows a block diagram of an apparatus suitable to perform the inventive method.

FIG. 6 shows a graph of the resulting residuals using the geometry free solution plotted versus epochs for a run labeled ALURE #4.

FIG. 7 shows a graph of the resulting residuals plotted versus epochs, using the geometry annihilation and hypothesis testing scheme for the same run labeled ALURE #4.

FIG. 8A shows a plot of range position versus time for a run labeled ALURE #2.

FIG. 8B shows a plot of an error term for the run of FIG. 8A.

FIG. 9 shows a table of the least squares method results according to the invention.

FIG. 10 shows a table of definitions of symbols used in the theoretical discussion.

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

### DETAILED DESCRIPTION

As described hereinabove, GPS blockage, or a momentary loss of received GPS satellite signals can interfere with high resolution GPS distance and/or position determinations. Blockage is problematic for a number of reasons. For example, when using prior art sequential calculations that continue until a desired error threshold is reached, blockage or other factors that cause convergence errors can cause a particular acquisition/computation cycle to continue for an undefined amount of time, or can continue indefinitely. Such error thresholds are generally defined by a bound value. In a worst case scenario, an individual acquisition can continue indefinitely without providing a solution distance and/or position. When one or more satellites which were contributing to a position calculation become blocked, and then re-appear, it might take several cycles to restore confidence below the bound value in the data (also referred to as “observables” or “GPS observables”) from the reappeared satellite. In addition, in many prior art sequential solutions, blockage and/or other factors which cause solutions beyond the bound values can cause an algorithm to restart. Since acquisitions might cease during the restart process, such restarts can cause loss of observable data (GPS observables) for a period of time.

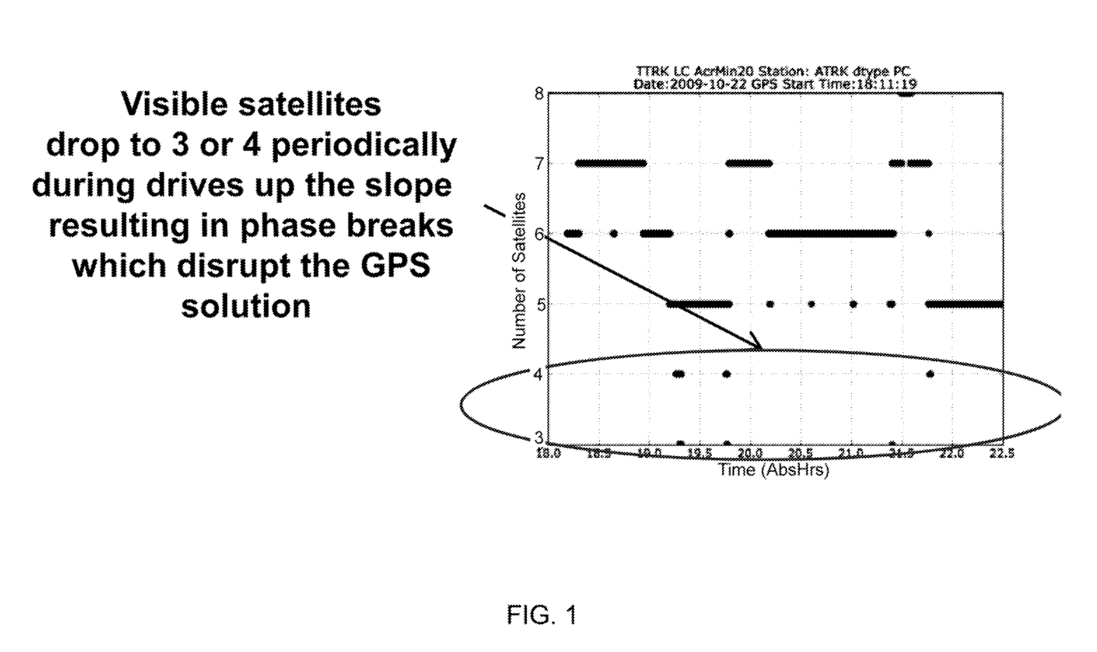

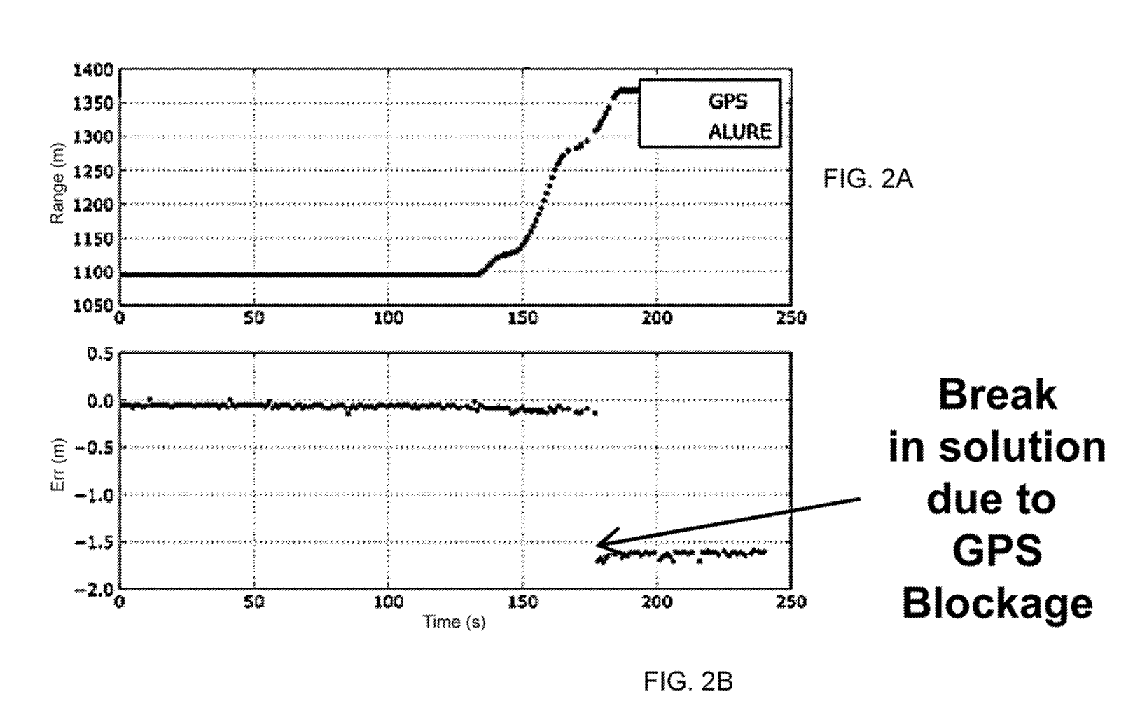

The problem of satellite blockage in high resolution differential GPS techniques was demonstrated in series of tests at the NASA JPL Optical Communications Telescope Laboratory (OCTL) facility. Studies of differential GPS techniques were performed using distance data from a co-located high accuracy, high resolution laser ranging system called Aircraft Laser Uplink Ranging Experiment (ALURE). During these GPS experiments, the ALURE laser range finding system provided distance benchmarks. FIG. 1 shows one exemplary graph of the number of satellites received plotted against time while a vehicle was driving up a test track slope. The graph of FIG. 1 shows that the number of visible satellites periodically dropped below 4 due to blockage. Using conventional GPS distance/position calculation methods, such blockages as shown in FIG. 1 caused a break in the solution resulting in distance errors on the order of meters. FIG. 2A shows a graph of range distance versus time for one exemplary test run. FIG. 2B shows a graph of the GPS distance calculation for the same test run and time period of FIG. 2A. The break in solution between 150 seconds and 200 seconds caused an error of about −1.5 meters in the GPS distance calculation as compared to the benchmark ALURE laser range values. Since the desired resolution for this test was on the order of 5 cm, the distance error was unacceptable.

Sophisticated software tools exist for processing data from two or more GPS receivers (differential GPS). For example, the GIPSY/OASIS (Global Navigation and Satellite Systems (GNSS)-Inferred Positioning System and Orbital Analysis Software) is available from NASA JPL, 4800 Oak Grove Drive, Pasadena, Calif. 91109 for use outside of NASA under a license agreement. GIPSY is a set of computer programs used to analyze radio-metric data, with an emphasis on GPS. JPL has used the GIPSY/OASIS software system in some applications to process datasets of observables in a post-processing mode. In some embodiments, the inventive method including the annihilation method described hereinbelow can be used as an enhancement to the GIPSY method.

In “Hypothesis testing for resolving integer ambiguity in GPS,” Navigation: Journal of the Institute of Navigation, vol. 50, no. 1, pp. 45-56, 2003, J. D. Wolfe, W. R. Williamson, et. al. described a new sequential differential GPS method. Using the Wald test for integer ambiguity resolution, the sequential method has been used for real-time distance calculations. For example, in “An instrumentation System Applied to Formation Flight,” IEEE Transactions on Control Systems Technology, Vol. 15, Issue 1, January 2007, pp 75-85, reported by W. R. Williamson, et. al. the 2003 sequential method was used during flight tests to control in real time the flight paths of two NASA F-18 aircraft flying in formation.

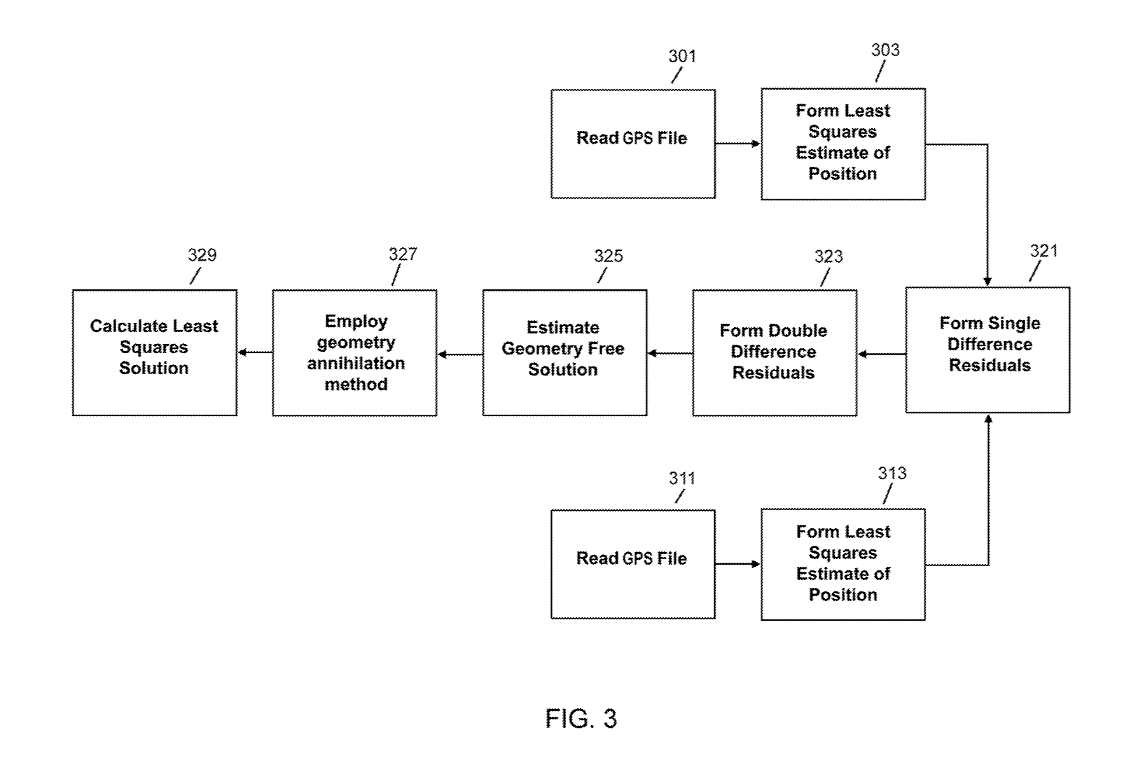

The present invention uses a batch series method instead of the prior art Wald test. This allows one to operate in a batch operating mode instead of in the prior art sequential method. FIG. 3 shows a block diagram of one generalized embodiment of a batch mode least squares differential GPS method according to the invention, using a plurality of GPS receivers. In this differential GPS method, there are at least two typically dual band (e.g., L1, L2) GPS receivers spaced apart by a distance D along a baseline. Each GPS receiver has attached to it a suitable GPS receiving antenna (e.g., a GPS L1, L2 choke ring antenna). Each GPS receiving antenna is typically fixed in position relative to its corresponding GPS receiver. While we refer herein for convenience, to a “position of” (e.g., an absolute position in any suitable physical frame of reference, such as a frame of reference defined by a plurality of GPS satellites) or “distance between” (D) two or more GPS receivers, it is understood that any distance measurements are actually between the respective GPS antennas. In the event that the respective antennas are positioned in the same relative position on each corresponding GPS receiver (or on the same relative position on each object having a GPS receiver, such as on a selected position on an airplane), the distance between the antennas can be used to determine relative positions of the objects to which the antennas are attached. Following recording of GPS observables for a period of time, as shown in blocks 301 and 311 of FIG. 3, a data file of GPS observables (observations) is read from each of the at least two GPS receivers respectively. Such observables typically include a plurality of GPS L1, P1 and GPS L2, P2 data (“L” denotes GPS carrier, “P” denotes GPS code). Typically such files are recorded in a standard GPS file format, such as the RINEX file format. However any suitable file format can be used. Next, according to the inventive batch mode approach, after data acquisition has occurred for a period of time, the following steps illustrated in FIG. 3 are performed on the entire set of GPS observables which was collected for the period of time: In blocks 303 and 313, for each of the GPS receivers respectively, a least squares estimate position is calculated. Typically a PC combination (the ionosphere free code combination), a LC combination (the ionosphere free carrier phase combination), a LWL combination (wide lane carrier phase combination), and/or a PNL combination (narrow lane code combination) are calculated from the L1, P1 and L2, P2 data. In block 321 a plurality of single difference residuals are formed based on the observables. Typically, a plurality of single difference residuals can be formed as a LWL combination, a PNL combination, and/or a PC combination. In block 323, a plurality of double difference residuals are calculated based on the plurality of single difference residuals. Typically, the double difference residuals can also be formed as a LWL combination, a PNL combination, and/or a PC combination. In block 325, an estimate of a geometry free solution is calculated. The geometry free solution calculation can include an estimate of a double difference ambiguity using a LWL−PWL combination, an estimate and fix integer by averaging LWL−PNL over each arc length and/or filtering and removing LWL+fix−PNL outlier estimates greater than a bound value. In block 327, geometric annihilation is applied to the geometry free solution. Suitable exemplary annihilation methods are described in more detail in the theoretical section hereinbelow. In block 329, a least squares solution is calculated to provide a measurement of the distance D. The least squares solution can include an absolute position of at least one of said first GPS receiver and said second GPS receiver relative to said plurality of GPS satellites. FIG. 2A and FIG. 2B show an initial solution without the geometry annihilation and hypothesis testing method step in FIG. 3.

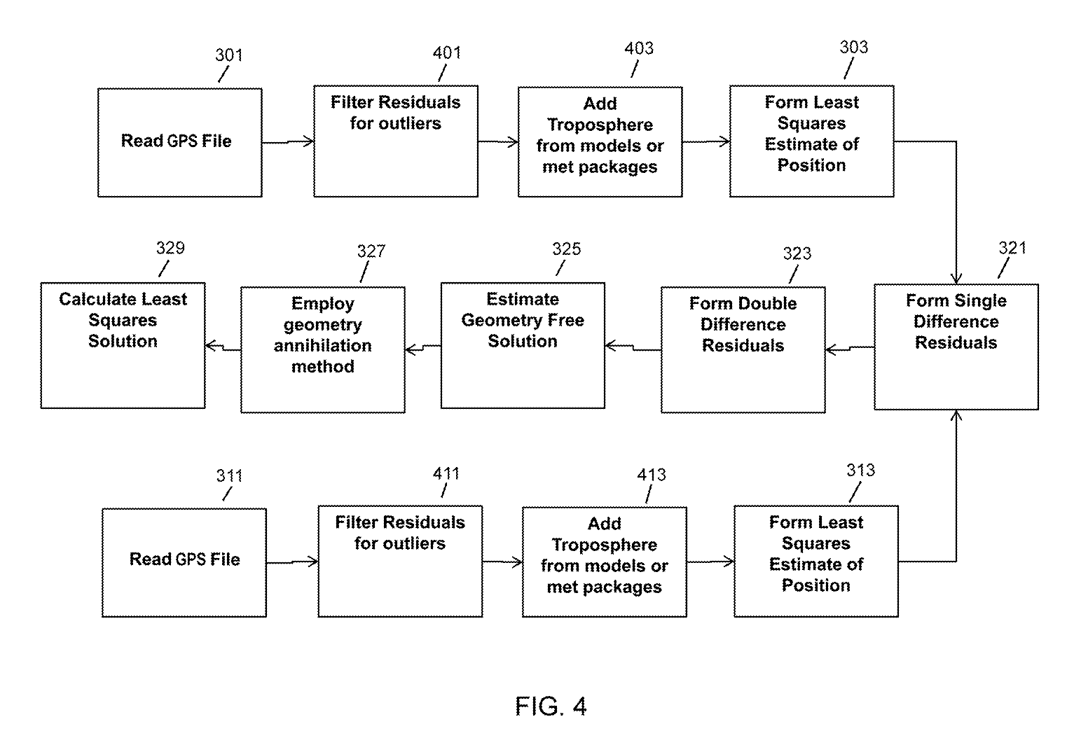

FIG. 4 shows a block diagram of another embodiment of a batch mode least squares differential GPS method according to the invention. In the method of FIG. 4, there are two additional steps, each of which can be optionally applied in a batch mode to the observables data from two or more GPS receivers, respectively. For example, in blocks 401 and 411, after the step of receiving observables and before the step of calculating a least squares estimate position, a step of processing residuals to remove outlying data which exceeds a bound value can be added. Exemplary data filters which can be applied to observables, as in optional blocks 401 and 411, include removing bad range or a range rate (e.g., a range rate in excess of 1000 m/s), removing a bad carrier or any data acquired during a loss-of-lock indication, removing data where the signal strength for a given satellite is below 1, and removing any L1, P1 or L2, P2 combination if both the code and carrier are not present (e.g., if a data point appears to be absent entirely).

Blocks 403 and 413 optionally can be added, which denote steps which occur after the step of receiving observables and before the step of calculating a least squares estimate position, that include a step of calculating corrections based on a measured or a modeled data of GPS radio propagation conditions of the Troposphere. This step of calculating corrections (indicated in blocks 403, 413) can be accomplished, for example, by calculating corrections using an annihilation technique with modeled data of GPS radio propagation conditions of the Troposphere. Altitude based dry and wet models, such as those using Niell mapping functions, can also be used.

The steps of the methods illustrated in FIG. 3 and FIG. 4 can be performed by a data processor including any suitable type of computer, such as a general purpose programmable computer running a suitable set of instructions recorded on a machine-readable medium. A suitable data processor or general purpose computer can be a standalone device, or it can be located on board a vehicle, a ship, a satellite, or an aircraft. The vehicle, ship, satellite, or aircraft can also have on board one of the GPS receivers used to perform the distance measurement. The data processor or general purpose programmable computer can receive the GPS observables from two or more GPS receivers by any suitable data transfer mechanism including transfer using any suitable type of wired or wireless data connection or via transfer using data recorded on a machine-readable medium. In an alternative embodiment, any one of or all of the GPS receivers can receive GPS observables from each other and any one of the GPS receivers can include within it an embedded data processor configured to perform the process steps of the inventive method (e.g., as shown in FIG. 3 and FIG. 4) to determine a distance D between any two of the GPS receivers.

The inventive batch mode alternative to the prior art Wald test approach provides several advantages. Since the observables are collected over a period of time, before being batch processed, observables are not lost by restarted calculations. In addition, when a satellite re-appears following a blockage, the sequential problem of how to handle the observables from a newly appeared satellite are eliminated. The batch mode can discard periods of lesser quality satellite observables (e.g., less than four or five simultaneous satellite observations) without degrading better sets of observables immediately following the degraded observation period. Using the inventive method, any period of any time can be automatically discarded by the inventive method. Thus only periods of observable data which provides position data within a desired bounds can be used, without the degradation or loss of data immediately following such discarded data as can result when using the prior art sequential method.

Now in more detail, with regard to the annihilation hypothesis testing scheme, two residuals using PNL, LWL, and an a priori estimate of relative range and M residuals, each one based on a different hypothesized integer ambiguity N can be formed using equation 1:

$$[ \begin{matrix}λ ( ∇ Δ \tilde{φ} + ∇ Δ {\overline{N}}_{i} ) - ∇ Δ \overline{ρ} \\ λ ( ∇ Δ \tilde{φ} + ∇ Δ {\overline{N}}_{i} ) - ∇ Δ {\overline{ρ}}_{NL}\end{matrix} ] = [ \begin{matrix}- λ I \\ - λ I\end{matrix} ] ∇ Δ {N}_{hyp} + \\ [ \begin{matrix}∇ H δ x \\ 0\end{matrix} ] + [ \begin{matrix}{v}_{φ} \\ {v}_{φ} + {v}_{ρ}\end{matrix} ] \qquad EQ . 1$$

An annihilator E can be formed to remove the effect of position error using equation 2 and equation 3:

$$\begin{matrix}E = I - ∇ {H ( ∇ {H}^{T} ∇ H )}^{- 1} ∇ {H}^{T} & EQ . 2 \\ \begin{matrix}r = [ \begin{matrix}E ( λ ( ∇ Δ \tilde{φ} + ∇ Δ {\overline{N}}_{i} ) - ∇ Δ \overline{ρ} ) \\ λ ( ∇ Δ \tilde{φ} + ∇ Δ {\overline{N}}_{i} ) - ∇ Δ {\tilde{ρ}}_{NL}\end{matrix} ] \\ = [ \begin{matrix}- λ E \\ - λ I\end{matrix} ] ∇ Δ {N}_{i} + [ \begin{matrix}{Ev}_{φ} \\ {v}_{φ} = {v}_{ρ}\end{matrix} ]\end{matrix} & EQ . 3\end{matrix}$$

The probability density function sᵢ of the residual process can be calculated, for example, using a Gaussian as shown by equation 4 and equation 5:

$$\begin{matrix}{s}_{i} = \frac{1}{{( 2 π )}^{n / 2} \sqrt{\vert V \vert}} exp ( \frac{- 1}{2} {r}_{i}^{T} {V}^{- 1} {r}_{i} ) & EQ . 4 \\ V = ExpectedValue [ {[ \begin{matrix}{Ev}_{φ} \\ {v}_{φ} = {v}_{ρ}\end{matrix} ] [ \begin{matrix}{Ev}_{φ} \\ {v}_{φ} = {v}_{ρ}\end{matrix} ]}^{T} ] & EQ . 5\end{matrix}$$

Next, turning to the scoring method, a batch probability Fᵢ can be calculated for each hypothesis relative to other hypotheses for an arc of k epochs (e.g., an epoch can be defined as a time interval, such as a second) using an initial probability for each hypotheses pi using exemplary equation 6

$${F}_{i} ( k ) = \frac{{p}_{i} {\prod }_{j = 0}^{k} {s}_{i} ( j )}{{\sum }_{i = 1}^{M} [ {p}_{i} {\prod }_{j = 0}^{k} {s}_{i} ( j ) ]} \qquad EQ . 6$$

Equation 6 is used in the batch method according to principles of the invention. In other embodiments, any other suitable batch type equation can be substituted for equation 6.

By contrast, the Wald method was used in the prior art sequential method using the relations given in Equations 7:

$${F}_{i} ( k ) = \frac{{F}_{i} ( k - 1 ) {s}_{i} ( k - 1 )}{{\sum }_{i = 1}^{M} {F}_{i} ( k - 1 ) {s}_{i} ( k - 1 )} \\ {F}_{i} ( 0 ) = {p}_{i} \qquad EQ . 7$$

### Experimental Data

### The Optical Communications Telescope Laboratory Test Range

The Optical Communications Telescope Laboratory (OCTL) test setup and system was described by Walton Williamson in “Comparison of Laser and Differential GPS Ranging Approaches,” JPL Interplanetary (IPN) Progress Report 42-181, May 15, 2010. The IPN report described a ground based experiment to validate a new laser ranging device and a Global Positioning System (GPS) relative position estimation scheme. The reports was based on the prior art sequential method and did not describe the batch method according to the invention. However, we include hereinbelow an excerpt from that report which provides an introduction to the test range.

The goal of the JPL IPN reported tests was to compare the laser and differential GPS range solutions and to determine the challenges to achieving agreement to within 10 cm root-mean-square (RMS) during dynamic tests. A truck was used as the dynamic target. The experimental data described hereinbelow took place at the same test range, in Wrightwood, Calif. at the JPL Table Mountain Facility. The laser and a GPS receiver were placed at the OCTL at Table Mountain. A retro reflector and GPS receiver were mounted in the bed of a pick-up truck. The test plan called for the truck to drive up a ski run in the valley below at speeds from 2 to 11 meters per second (m/s) as allowed by the terrain at a distance of 1.2 to 1.5 km from the OCTL. GPS data was collected from both locations and post-processed. The GPS receivers at both locations were commercial, off-the-shelf (COTS) geodetic quality receivers with choke-ring antennas to mitigate multipath effects.

### GPS Terms of Art

GPS code and carrier phase measurements were collected from both the truck and the OCTL ground station to form an estimate of the relative position between the two positions. Since the GPS receivers used can track carrier phase to less than one centimeter, relative positions may be estimated to centimeters. One challenge to achieving accurate centimeter-level range measurements between two locations is to resolve the unknown integer ambiguity between the two GPS receivers.

One relatively simple method for short baseline processing is to implement a “geometry free” estimator of the wide-lane carrier phase ambiguity such as the method used to initialize the algorithm. Using this algorithm the “wide lane” combination of the L1 and L2 carrier phase measurements from both the truck and the ground station are collected. The wide lane carrier phase is used to form a double difference residual and then differenced with the double differenced “narrow lane” code combination. This residual, when averaged over time, should provide an estimate of the wide-lane integer ambiguity (assuming no multipath effects). The ambiguity is resolved through statistical testing of the average of the RMS error in the double differenced residual using assumed noise covariance for code and carrier phase. Once the ambiguity is resolved, the double differenced carrier phase measurements can be converted to a relative range measurement between the truck and OCTL. These range measurements are processed through a least squares estimation technique to determine the relative positions of the truck and ground station.

However, geometry free estimates are not sufficient for this application for two reasons. First, the arc lengths are not sufficiently long over the length of the run to properly estimate the integer ambiguity, given assumed measurement noise statistics. Arc lengths were cut short due to satellite blockage. As the truck traveled up the ski run, trees, parts of the ski lift, and the mountain and adjacent mountain peaks obstructed the line of site to the satellites. Second, reflections from these obstructions posed a significant code multipath problem.

Now returning to experimental data according to the invention, an alternative strategy that improved the convergence time of the geometry free solution was therefore implemented initially based on the sequential method followed by the batch method according to principles of the invention and described hereinabove.

### Hardware

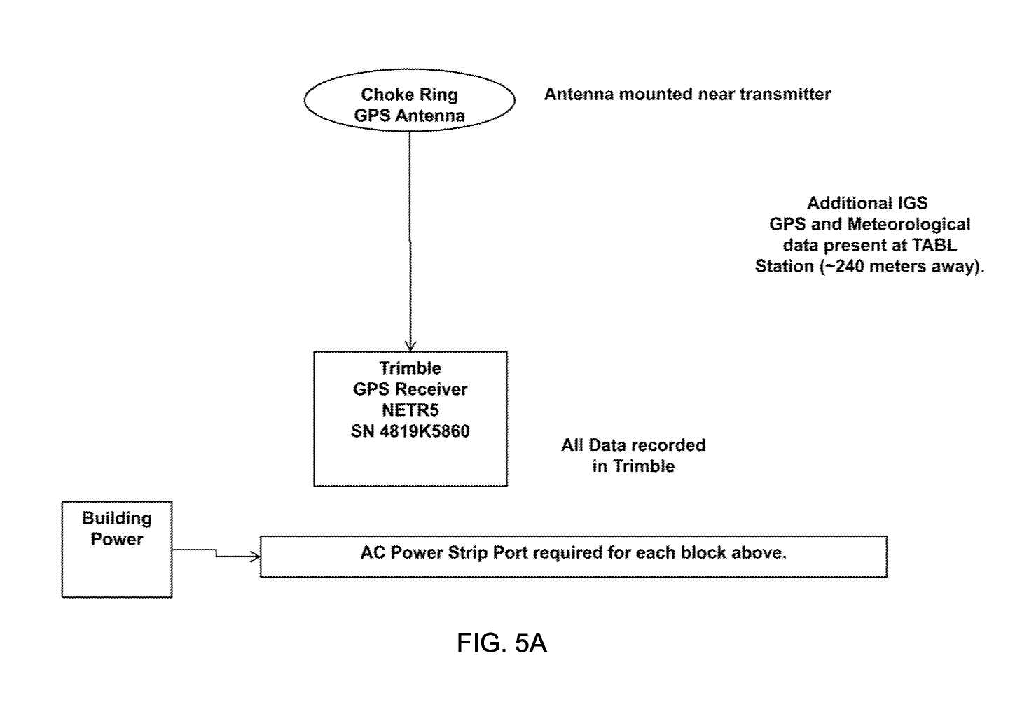

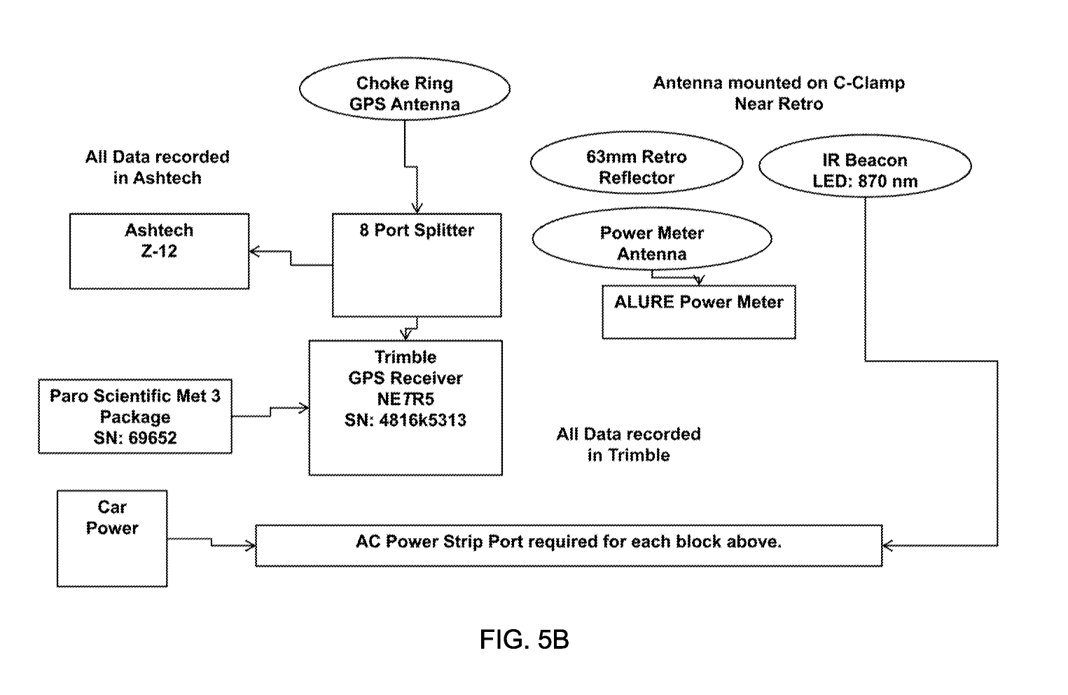

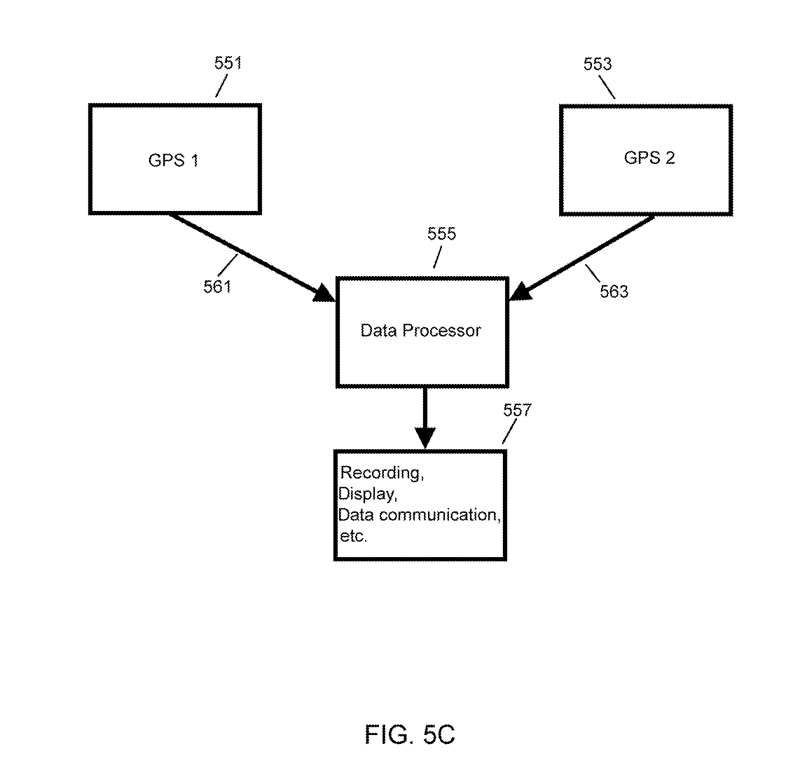

FIG. 5A shows a block diagram of the hardware configuration at the laser transmitter of the ALURE laser range finder. FIG. 5B shows a block diagram of the remote truck (vehicle) hardware configuration.

As described hereinabove, the steps of the methods illustrated in FIG. 3 and FIG. 4 can be performed by a data processor including any suitable type of computer, such as a general purpose programmable computer running a suitable set of instructions recorded on a machine-readable medium. FIG. 5C shows a block diagram of the processing general methodology using an exemplary apparatus suitable to perform the inventive method. A data processor 555 is configured to receive a plurality of GPS observables observed over a fixed time period from each of a first GPS receiver 551 (e.g., FIG. 5A) and a second GPS receiver 553 (e.g. FIG. 5B), each GPS receiver having its own GPS antenna (not shown in FIG. 5C). The first GPS receiver and the second GPS receiver are spaced apart by a distance D, said distance D to be determined. The data processor 555 has instructions in machine-readable form recorded therein. At least one device 557 is selected from a recording device configured to record a distance result, a display device configured to display said distance result, and a communications device configured to provide said distance result to another device (not shown in FIG. 5C). The data processor 555 (e.g., a general purpose programmable computer) can receive the GPS observables from two or more GPS receivers by any suitable data transfer mechanism including transfer using any suitable type of wired or wireless data connection or via transfer using data recorded on a machine-readable medium (FIG. 5C 561, 563).

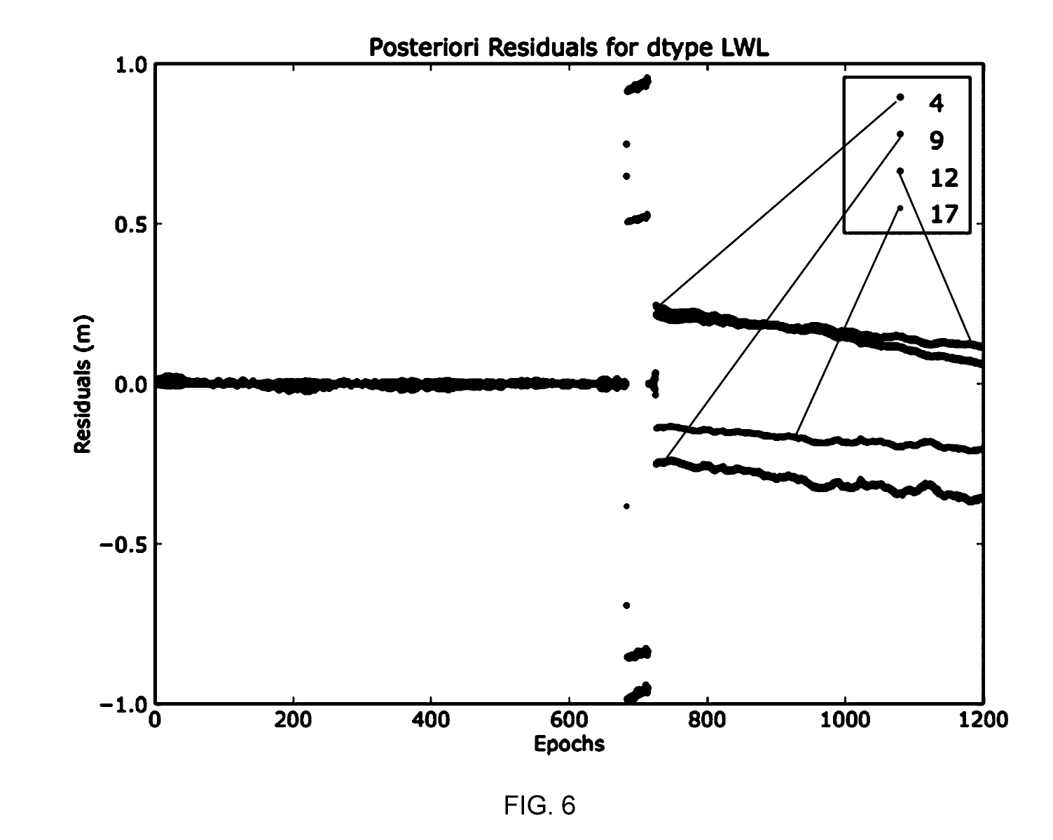

Comparing Prior Art Methods with the Inventive Least Squares Batch Method FIG. 6 shows a graph of the resulting residuals using the geometry free solution plotted versus epochs for a run labeled ALURE #4. This data run showed that a geometry free solution alone has problematic phase breaks associated with GPS satellite blockage.

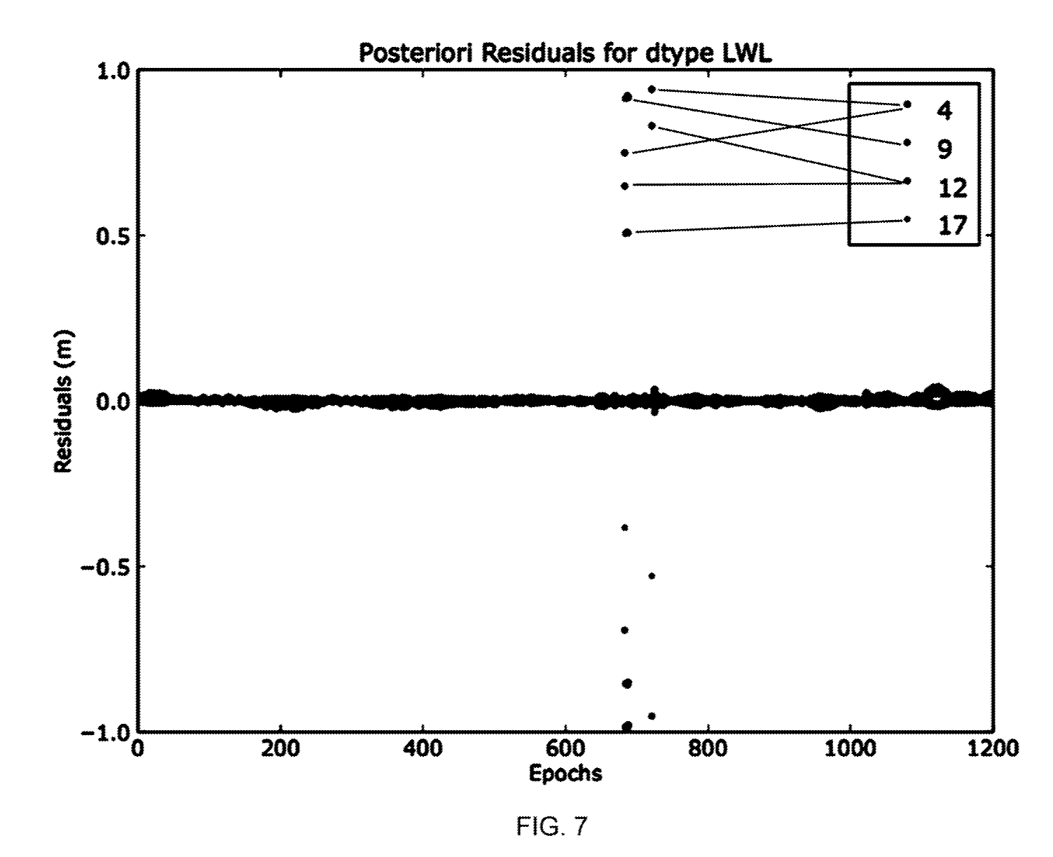

FIG. 7 shows a graph of the resulting residuals plotted versus epochs, using the geometry annihilation and hypothesis testing scheme for the same run labeled ALURE #4. The remaining outliers could be removed with further post-processing.

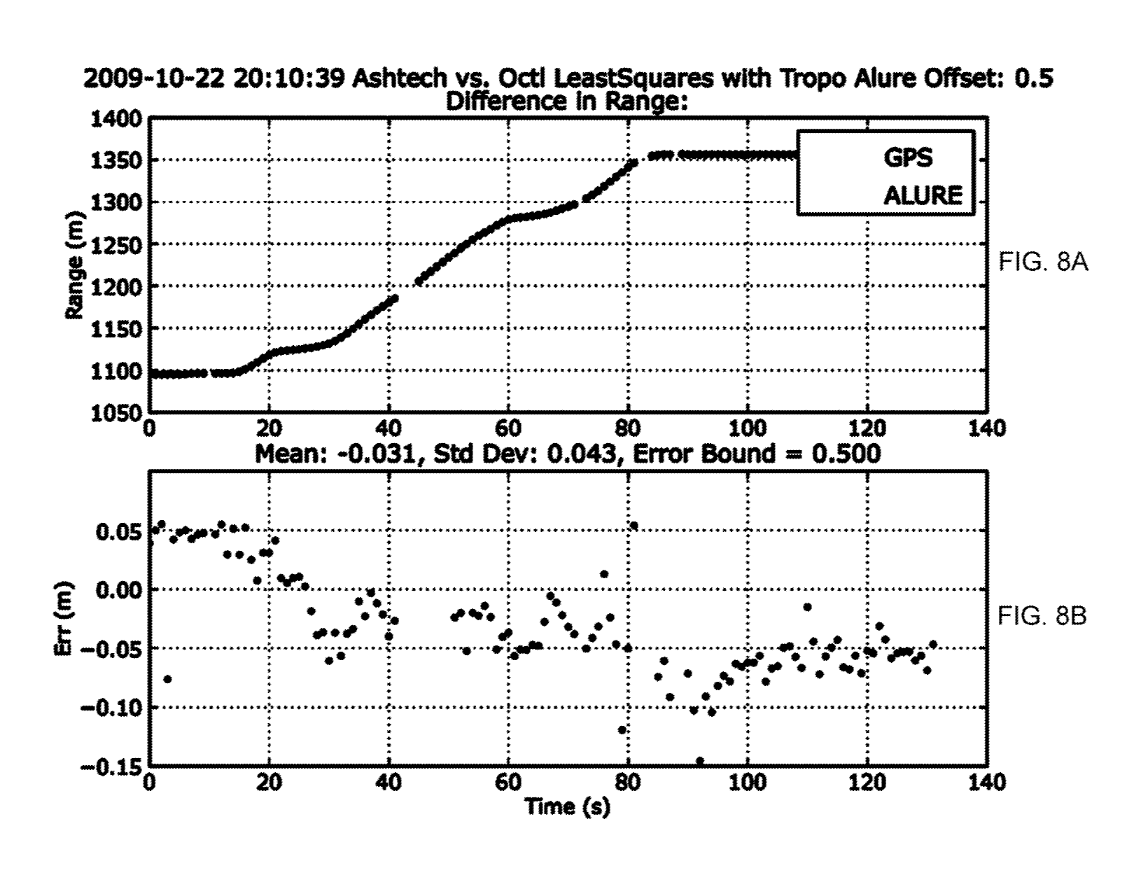

FIG. 8A and FIG. 8B show the resulting relative range as compared with a reference laser. FIG. 8A shows a plot of range position versus time for a run labeled ALURE #2. FIG. 8B shows a plot of an error term for the run of FIG. 8A. The relative position estimate compares well with the ALURE system. In the scale of FIG. 8A, the data points substantially overlap.

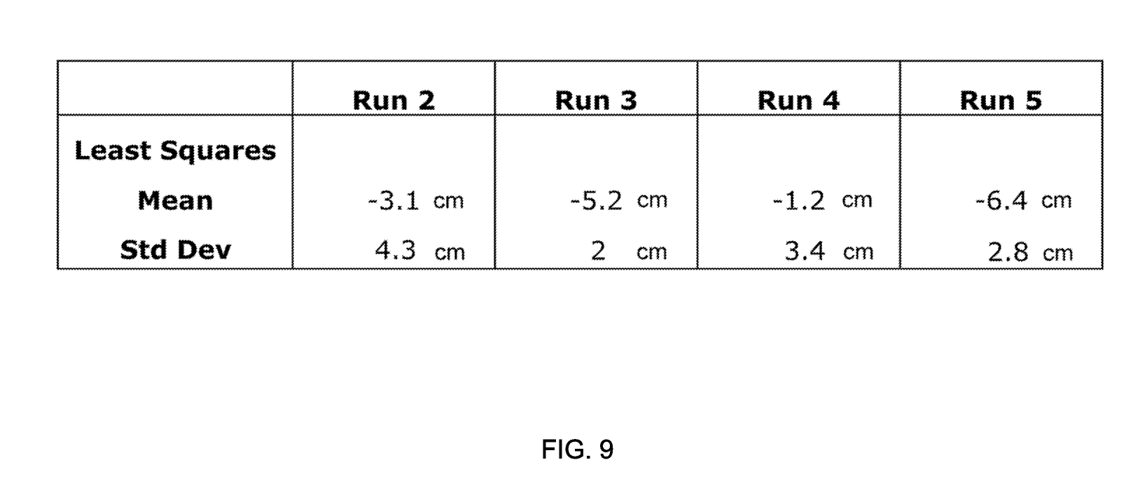

FIG. 9 shows a table of the least squares method results according to the invention. The least squares solution showed less than a 6.4 cm bias and less than a 4.3 cm standard deviation over the dynamic runs. Moreover, no velocity dependence was detected.

### Theoretical Discussion

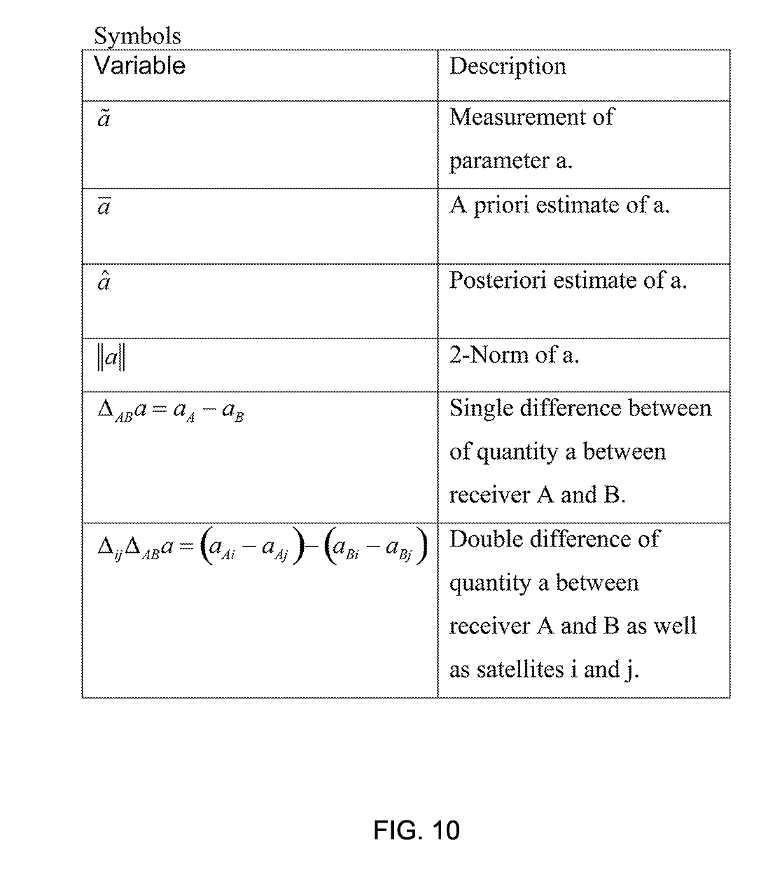

A more detailed description of several functional blocks (FIG. 3 and FIG. 4) of the method is presented hereinbelow. The first section discusses the measurement model and assumptions on the code and carrier phase measurements. The second section presents a simple least squares estimation method for calculating the initial position of each receiver and the initial relative position. The third section discusses code and carrier phase combinations for eliminating error sources and constructing wide lane carrier phase observables. Then these combinations are utilized in the fourth section to form single and double differences. The “geometry free” residual is introduced in the fifth section. The annihilation method is presented as an enhancement in the sixth section. The overall statistical testing batch processing approach and method is as described hereinabove. FIG. 10 shows a table of definitions of symbols used in the theoretical discussion.

### Measurement Models

The following simplified model defines the range equation for the carrier phase in cycles for each frequency. In this case, the phase \tilde{φ}_{L1}^{Ai} represents the received phase in cycles of the L1 carrier frequency on receiver A from satellite i. The measured phase \tilde{φ}_{L1}^{Ai} plus an unknown integer number of cycles N_{L1}^{Ai} multiplied by the wavelength λ_{L1} is equal to the range between receiver A and the satellite i plus errors associated with the atmosphere, multipath and the GPS receiver. If an a priori estimate of the position and clock bias of the GPS receiver and GPS satellite is available, then the a priori range is defined as ρ̅^{Al}, the a priori receiver clock bias is τ̅_{A}, and the a priori satellite clock bias is τ̅ᵢ. Both clock biases are in seconds and are multiplied by the speed of light c. The Troposphere error is defined as T^{Ai}. The ionosphere error is defined as I_{L1}^{Ai}; for the L1 frequency. The multipath on the L1 channel between satellite i and receiver A is m_{L1}^{Ai} and the receiver noise is υ_{L1}^{A}.

λ_{L1}(\tilde{φ}_{L1}^{Ai}+N_{L1}^{Ai})= ρ̅^{Ai}+H^{Ai}δx_{A}+c τ̅_{A}+c τ̅ᵢ+T^{Ai}−I_{L1}^{Ai}+m_{L1}^{Ai}+υ_{L1}^{A} (8)

The error in the a priori estimate of receiver position and clock bias are used to define the state space for δx_{A}. In this case, the vector δx_{A} is a 4×1 vector where the first three terms are the error in position in the Earth-Centered, Earth Fixed reference frame and the fourth term is the error in the receiver clock bias. The matrix H^{Ai} is a 1×4 matrix containing the line of sight and clock bias sensitivity matrix. H^{Ai} is defined as:

$${H}^{Ai} = [ \begin{matrix}\frac{{\overline{X}}^{i} - {\overline{x}}^{A}}{‖ {\overline{P}}^{i} - {\overline{P}}^{A} ‖} & \frac{{\overline{Y}}^{i} - {\overline{y}}^{A}}{‖ {\overline{P}}^{i} - {\overline{P}}^{A} ‖} & \frac{{\overline{Z}}^{i} - {\overline{z}}^{A}}{‖ {\overline{P}}^{i} - {\overline{P}}^{A} ‖} & 1.0\end{matrix} ] \qquad ( 9 )$$

In this case, the matrix is composed of the a priori satellite position vector P̅ⁱ=[ X̅ⁱ Y̅ⁱ Z̅ⁱ]^{T} and a priori receiver position vector P̅^{A}=[ x̅^{A} y̅^{A} z̅^{A}]^{T}. Errors in satellite clock bias and satellite position are neglected because they will eventually be removed along with other common mode errors.

The state space δx_{A} consists of the error in the three position estimates as well as the error in the clock bias.

δx_{A}=[δx^{A}δy^{A}δz^{A}cδτ^{A}]^{T}=[x^{A}− x̅^{A}y^{A}− y̅^{A}z^{A}− z̅^{A}τ− τ̅^{A}]^{T} (10)

For completeness, the following equation defines the equivalent error for the A, measured L2 carrier phase \tilde{φ}_{L2}^{Ai}. Note that offsets in the L2 carrier from L1 due to the satellite have been neglected for convenience.

λ_{L2}(\tilde{φ}_{L2}^{Ai}+N_{L2}^{Ai})= ρ̅^{Ai}+H^{Ai}δx_{A}+c τ̅_{A}+c τ̅ᵢ+T^{Ai}−I_{L2}^{Ai}+m_{L2}^{Ai}+υ_{L2}^{A} (11)

An equivalent set of pseudorange measurements \tilde{ρ}_{L1}^{Ai} can be constructed as shown in the next equation. Note that the ionosphere error sign is reversed and that the multipath error and receiver error are represented by M_{L1}^{Ai} and η_{L1}^{Ai}, respectively.

\tilde{ρ}_{L1}^{Ai}= ρ̅^{Ai}+H^{Ai}δx_{A}+c τ̅_{A}+c τ̅ᵢ+T^{Ai}+I_{L1}^{Ai}+M_{L1}^{Ai}+η_{L1}^{A} (12)

A similar expression is presented for the L2 pseudorange. In this case, we are assuming that the L1 pseudorange is derived from the C/A code and the L2 pseudorange is either the L2 C/A code if available or else a pseudorange derived from codeless tracking of the L2 P code. However, cross-correlation with the L1 pseudorange or any of the carrier phases is neglected for the current analysis.

\tilde{ρ}_{L2}^{Ai}= ρ̅^{Ai}+H^{Ai}δx_{A}+c τ̅_{A}+c τ̅ᵢ+T^{Ai}+I_{L2}^{Ai}+M_{L2}^{Ai}+η_{L2}^{A} (13)

For quick positioning of a receiver, the ionosphere-free code combination can be formed and then processed through a weighted least squares estimator to estimate δx_{A}. This process is accomplished in the next few steps. It is assumed that the satellite positions and clock bias are provided by the GPS transmitted ephemeris processed, for example, through the algorithm described by Remondi in “Computing the Satellite Velocity using the Broadcast Ephemeris,” GPS Solutions, Vol. 8. No 3, pp. 181-183, 2004.

### Least Squares Processing for Single Receivers

The ionosphere-free combination of the code is given in the following equation where γ=(77.0/60.0)², the ratio of L2 to L1 wavelengths squared.

$${\tilde{ρ}}_{IF}^{Ai} = \frac{{\tilde{ρ}}_{L 2}^{Ai} - γ {\tilde{ρ}}_{L 1}^{Ai}}{1 - γ} . \qquad ( 14 )$$

By stacking all available ionosphere free pseudoranges at receiver A into a single vector \tilde{ρ}_{lF}^{A}, the error in the receiver position and clock bias δx_{A} can be estimated using the following iterative method.

δ\hat{x}_{A}=K(\tilde{ρ}_{lF}^{A}− ρ̅^{A})

\hat{P}^{A}= P̅^{A}+δ\hat{x}_{A}[1-3]

\hat{τ}_{A}=\hat{τ}^{A}+δ\hat{x}_{A}[4] (15)

After each iteration, the new position vector \hat{P}^{A} is utilized to re-calculate the measurement sensitivity matrix H and a priori range ρ̅^{A}. The new matrix H may then be utilized to calculate the filter gain matrix K using the following expression:

K=(H^{T}V⁻¹H)⁻¹H^{T}V⁻¹ (16)

The matrix V represents the measurement noise covariance for the combined ionosphere free pseudoranges. The ionosphere error has been removed from the residual. A troposphere model such as the zenith delay combined with the mapping functions should be used to remove the majority of the troposphere error. However, satellite position errors, satellite clock bias errors, multipath, and receiver noise are all still included in the current error sources.

This algorithm is sufficient to provide an initial position estimate for the differential carrier phase algorithm described in the next section. The algorithm converges provided sufficient satellite geometry exists for the numerical inversion in the gain calculation.

### Code-Carrier Combinations

Several code and carrier phase combinations along with the associated error sources are now defined. The “wide lane” carrier phase combination is defined using the L1 and L2 carrier phases as shown below where cis the speed of light, f_{L1} is the L1 carrier frequency and f_{L2} is the L2 carrier frequency.

$$\begin{matrix}{λ}_{WL} {\tilde{φ}}_{WL}^{Ai} = \frac{c ( {\tilde{φ}}_{L 1}^{Ai} - {\tilde{φ}}_{L 2}^{Ai} )}{{f}_{L 1} - {f}_{L 2}} \\ = \frac{{f}_{L 1} {λ}_{L 1} {\tilde{φ}}_{L 1}^{Ai} - {f}_{L 2} {λ}_{L 2} {\tilde{φ}}_{L 2}^{Ai}}{{f}_{L 1} - {f}_{L 2}}\end{matrix} \qquad ( 17 )$$

This combination has the advantage that the wavelength λ_{WL} is 86.2 cm and that resulting range measurement still has an unknown integer ambiguity N_{WL}^{Ai}, which is a larger wavelength than either the N_{L1}^{Ai} or N_{L2}^{Ai} integer wavelengths.

The “narrow lane” code combination can be defined using the pseudorange for L1 and L2 as shown in the next equation. The term narrow lane comes from the fact that a similar combination of the carrier phases has a much “narrower” wavelength. This combination of pseudoranges is convenient since it can be used to remove ionosphere errors from the wide lane measurements.

$${\tilde{ρ}}_{NL}^{Ai} = \frac{{f}_{L 1} {\tilde{ρ}}_{L 1}^{Ai} + {f}_{L 2} {\tilde{ρ}}_{L 2}^{Ai}}{{f}_{L 1} + {f}_{L 2}} \qquad ( 18 )$$

Given that the ionosphere error on the L1 and L2 frequencies are both a function of Total Electron Count (TEC), it is possible to write both frequency dependent variables as a function of a single variable I_{TEC}.

$${I}_{L 1} = \frac{{f}_{L 2}^{2} {I}_{TEC}^{Ai}}{{f}_{L 1}^{2} - {f}_{L 2}^{2}} \\ {I}_{L 2} = \frac{{f}_{L 1}^{2} {I}_{TEC}^{Ai}}{{f}_{L 1}^{2} - {f}_{L 2}^{2}} \qquad ( 19 )$$

Using this relationship, we note that it is possible to form a difference between the wide lane carrier and the narrow lane code, which has the following form. The error sources are limited to multipath and receiver noise. Errors associated with the ionosphere have been removed by use of this particular code and carrier combination. The error in position, clock bias, and troposphere has been removed because these errors are common to both frequencies.

λ_{WL}(\tilde{φ}_{WL}^{Ai}+N_{WL}^{Ai})−\tilde{ρ}_{WL}^{Ai}=m_{WL}^{Ai}+M_{NL}^{Al}+υ_{WL}^{Ai}+η_{NL}^{Ai} (20)

This measurement can be utilized to estimate the wide lane integer N_{WL}^{Ai} on a satellite-by-satellite basis without knowledge of orbits or position. However, this combination is only presented to show how a combination of wide and narrow lane measurements reduces all error sources. The next section will attempt to estimate the double differenced integer in order to initialize the process.

### Single and Double Differences

Consider two GPS receivers, A and B, within a baseline distance of a few kilometers. If both receivers view the same satellite i, then a single difference may be formed by differencing either the pseudorange or carrier phase viewed at both receivers. This single difference has the following error model for the wide lane carrier phase observable. In this case, the term Δ_{AB} represents the difference between a term measured at receiver A minus the term measured at receiver B.

λ_{WL}(Δ_{AB}\tilde{φ}_{WL}ⁱ+Δ_{AB}N_{WL}ⁱ)=Δ_{AB} ρ̅ⁱ+HⁱΔ_{AB}δx_{A}+Δ_{AB}c τ̅+Δ_{AB}m_{WL}ⁱ+Δ_{AB}υ_{WL}+Δ_{AB}I_{WL}ⁱ+Δ_{AB}T_{WL}ⁱ (21)

The error model makes the assumption that, because the baseline is short, the line of sight matrix for satellite i, Hⁱ is approximately the same for both receivers. In addition, errors in the satellite position and clock bias are also eliminated. An argument could be made that the ionosphere and troposphere errors will disappear over short baselines. However, some residual error will be present and these terms are kept temporarily.

A similar model is formed for the narrow lane code observable as shown in the next equation:

Δ_{AB}\tilde{ρ}_{NL}ⁱ=Δ_{AB} ρ̅ⁱ+HⁱΔ_{AB}δx_{A}+Δ_{AB}c τ̅_{A}+Δ_{AB}M_{NL}ⁱ+Δ_{AB}η_{NL}+Δ_{AB}I_{NL}ⁱ+Δ_{AB}T_{NL}ⁱ (22)

If both receivers observe the same two satellites i and j, then a double differenced observable can be formed from the two single differenced observables.

λ_{WL}(ΔᵢⱼΔ_{AB}\tilde{φ}_{WL}+ΔᵢⱼΔ_{AB}N_{WL})=λ_{WL}(Δ_{AB}\tilde{φ}_{WL}ⁱ+Δ_{AB}N_{WL}ⁱ)−λ_{WL}(Δ_{AB}\tilde{φ}_{WL}^{j}+Δ_{AB}N_{WL}^{j})=ΔᵢⱼΔ_{AB} ρ̅+ΔᵢⱼHΔ_{AB}δx+ΔᵢⱼΔ_{AB}m_{WL}+ΔᵢⱼΔ_{AB}υ_{WL}+ΔᵢⱼΔ_{AB}I_{WL}+ΔᵢⱼΔ_{AB}T_{WL} (23)

In this case, the double difference has eliminated the relative clock bias. As such the state space represented by Δ_{AB}δx is reduced by one state, the clock bias. This relative state is now only a function of the difference in the error in the position of each receiver. The measurement sensitivity matrix is now reduced by one state since the relative clock bias between receiver A and B is removed. The new sensitivity matrix is defined below. Again, note that the line of sight matrix to each satellite is assumed equivalent at both receivers, which is true for short baselines on the order of kilometers.

$${Δ}_{ij} H = [ \begin{matrix}\frac{{\overline{X}}^{i} - {\overline{x}}^{A}}{‖ {\overline{P}}^{i} - {\overline{P}}^{A} ‖} & \frac{{\overline{Y}}^{i} - {\overline{y}}^{A}}{‖ {\overline{P}}^{i} - {\overline{P}}^{A} ‖} & \frac{{\overline{Z}}^{i} - {\overline{z}}^{A}}{‖ {\overline{P}}^{i} - {\overline{P}}^{A} ‖}\end{matrix} ] - \\ [ \begin{matrix}\frac{{\overline{X}}^{j} - {\overline{x}}^{A}}{‖ {\overline{P}}^{j} - {\overline{P}}^{A} ‖} & \frac{{\overline{Y}}^{j} - {\overline{y}}^{A}}{‖ {\overline{P}}^{j} - {\overline{P}}^{A} ‖} & \frac{{\overline{Z}}^{j} - {\overline{z}}^{A}}{‖ {\overline{P}}^{j} - {\overline{P}}^{A} ‖}\end{matrix} ] \qquad ( 24 )$$

The state space is simply the error in relative position

Δ_{AB}δx=[δx^{A}−δx^{B}δy^{A}−δy^{B}δz^{A}−δz^{B}] (25)

A similar relationship is defined for the double differenced narrow lane pseudorange.

ΔᵢⱼΔ_{AB}\tilde{ρ}_{NL}ⁱ=ΔᵢⱼΔ_{AB} ρ̅+ΔᵢⱼHΔ_{AB}δx+ΔᵢⱼΔ_{AB}M_{NL}+ΔᵢⱼΔ_{AB}η_{NL}+ΔᵢⱼΔ_{AB}I_{NL}+ΔᵢⱼΔ_{AB}T_{NL} (26)

### Geometry Free Baseline Estimation

If double differenced wide lane carrier phase is differenced with the double differenced narrow lane code, the relationship presented previously for wide lane carrier minus narrow lane code can be used to show that the effect of ionosphere is removed leaving only the double differenced wide lane integer ambiguity.

λ_{WL}(ΔᵢⱼΔ_{AB}\tilde{φ}_{WL}+ΔᵢⱼΔ_{AB}N_{WL})−ΔᵢⱼΔ_{AB}\tilde{ρ}_{NL}=ΔᵢⱼΔ_{AB}m_{WL}+ΔᵢⱼΔ_{AB}M_{NL}+ΔᵢⱼΔ_{AB}υ_{WL}+ΔᵢⱼΔ_{AB}η_{NL} (27)

The wide lane integer ambiguity may be solved directly assuming that the multipath and receiver noise are small in comparison to the wavelength. The solution is given in the next equation:

$$\begin{matrix}{Δ}_{ij} {Δ}_{AB} {N}_{WL}^{Ai} = {Δ}_{ij} {Δ}_{AB} {\tilde{φ}}_{WL}^{Ai} - \frac{1}{{λ}_{WL}} {Δ}_{ij} {Δ}_{AB} {\tilde{ρ}}_{NL}^{Ai} \\ = \frac{1}{{λ}_{WL}} ( {Δ}_{ij} {Δ}_{AB} {m}_{WL}^{Ai} + {Δ}_{ij} {Δ}_{AB} {M}_{NL}^{AI} + {Δ}_{ij} {Δ}_{AB} {υ}_{WL}^{Ai} + \\ {Δ}_{ij} {Δ}_{AB} {η}_{NL}^{Ai} )\end{matrix} \qquad ( 28 )$$

In practice, the above relationship is averaged over time in order to increase the probability of a successful fix. If a white noise model is assumed for both multipath and receiver noise, then the probability of a correct fix given a certain number of measurements can be calculated a priori.

This method has the advantage that it is simple, requires no knowledge of the relative position of either receiver, and has known convergence properties assuming zero mean multipath. However, multipath can have non zero mean and long correlation times making it possible to converge to the wrong integer even after time periods of smoothing that should statistically guarantee convergence.

The next section discusses a means to utilize all available GPS satellites in order to effectively estimate the double differenced integer ambiguity.

### Annihilators

A brief description of an annihilator is presented followed by the application to differential GPS. Supposing we have a linear matrix equation of the form where z, x, and y are vectors and H and G are matrices.

z=Hx+Gy (29)

Suppose that we wish to remove the effect of x on z entirely. If the matrix H has full row rank and if the dimension of z is at least one more dimension than x, then it is possible and useful to construct a matrix D such that DH=0 but DG≠0. Therefore the residual Dz=DGy exists and can be used to derive information about y without any effect from x.

The matrix D is referred to as the left annihilator of the matrix H. It is not unique, but one solution utilizes the pseudo inverse. It can be shown that the following relationship provides the desired effect such that DH=0.

D=I−H(H^{T}H)⁻¹H^{T} (30)

Consider the double differenced wide lane range residual below. In this case, all of the available double differenced carrier phase measurements have been put together into a single vector and the a priori estimate of range is used with the carrier to form the residual. If the effects of troposphere and ionosphere are removed due to a short base line separation between receiver A and B, then all that remains is the multipath, receiver error, and the error in the relative position. Note that multipath on carrier phase is significantly smaller than the multipath on the code measurements.

λ_{WL}(ΔΔ_{AB}\tilde{φ}_{WL}+ΔᵢⱼΔ_{AB}N_{WL})−ΔΔ_{AB} ρ̅=ΔHⁱΔ_{AB}δx_{A}+ΔΔ_{AB}m_{WL}^{Ai}+ΔΔ_{AB}υ_{WL}^{A} (31)

If an annihilator D is constructed such that DΔH=0, then the effect of uncertainty in the relative position between receiver A and B can be removed. This residual can be utilized with the geometry free solution to estimate the integer ambiguity using a hypothesis testing scheme. The resulting residual is given in the next equation.

D[λ_{WL}(ΔΔ_{AB}\tilde{φ}_{WL}+ΔᵢⱼΔ_{AB}N_{WL})−ΔΔ_{AB} ρ̅]=D(ΔΔ_{AB}m_{WL}^{Ai}+ΔΔ_{AB}υ_{WL}^{A}) (32)

The definition of the annihilator is given in the next equation. The ability to form the annihilator inherently assumes that there are a sufficient number of double differenced measurements (more than 3) with sufficient satellite geometry such that the inverse exists and is numerically well behaved.

D=I−ΔH(ΔH^{T}ΔH)⁻¹ΔH^{T} (33)

Combining this annihilated residual with the geometry free residual can provide a new test metric. While the annihilated residual can no longer be used to solve directly for the double differenced integer, if the correct integer is utilized, it will provide a zero mean residual. A statistical hypothesis testing scheme such as the one presented in the next section can be utilized to find the correct hypothesis in a set of test hypotheses.

### Hypothesis Testing

It is believed that the following method can be used for picking the double differenced integer ambiguity based on using the two residuals presented previously combined with statistical testing. In previous examples, ΔᵢⱼΔ_{AB}N_{WL} was unknown. An initial estimate of ΔᵢⱼΔ_{AB}N_{WL}, defined as ΔᵢⱼΔ_{AB} N̅_{WL} can be found by using the geometry-free estimation method smoothed over M time steps, where M is chosen based on the assumed statistics of the receiver noise or merely the data available. Note that the variable k denotes a time epoch.

$${Δ}_{ij} {Δ}_{AB} {\overline{N}}_{WL}^{Ai} = \frac{1}{M} {\sum }_{k = 1}^{M} [ {Δ}_{ij} {Δ}_{AB} {\tilde{φ}}_{WL} ( k ) - \frac{1}{{λ}_{WL}} {Δ}_{ij} {Δ}_{AB} {\tilde{ρ}}_{NL} ( k ) ] \qquad ( 34 )$$

With short amounts of data, M may be chosen using the number of time steps available. The probability that this a priori estimate is correct may be calculated assuming a Gaussian random variable with statistics, where V_{φ} is the covariance of the double differenced receiver phase noise and V_{ρ} is the covariance of the double differenced code measurements. It is currently, assumed that no multi-path is present for simplicity, although the covariance could be appropriately weighted if necessary. Note it is also assumed that the code and carrier phase receiver noises are independent and identically distributed Gaussians across all time epochs.

$$E [ {Δ}_{ij} {Δ}_{AB} {N}_{WL} ( k ) - {Δ}_{ij} {Δ}_{AB} {\overline{N}}_{WL} ( k ) ] = 0 \\ E [ {( {Δ}_{ij} {Δ}_{AB} {N}_{WL} ( k ) - {Δ}_{ij} {Δ}_{AB} {\overline{N}}_{WL} ( k ) )}^{2} ] = \frac{1}{{λ}_{WL}^{2}} [ {V}_{φ} + {V}_{ρ} ] \qquad ( 35 )$$

Therefore the covariance of the double differenced integer after smoothing for M steps is given in the next equation.

$$E [ {\sum }_{k = 1}^{M} {( {Δ}_{ij} {Δ}_{AB} {N}_{WL} ( k ) - {Δ}_{ij} {Δ}_{AB} {\overline{N}}_{WL} ( k ) )}^{2} ] = \frac{1}{M - 1} {\sum }_{k = 1}^{M} \frac{1}{{λ}_{WL}^{2}} [ {V}_{φ} + {V}_{ρ} ] \qquad ( 36 )$$

The preceding can be used to define an initial condition for the integer ambiguity ΔᵢⱼΔ_{AB} N̅_{WL}. Given a limited number of measurements and the presence of multipath on some or all of the measurements, the actual integer ambiguity lies in the near neighborhood with high probability. A set of integers ΔΔ N̅_{θ} are hypothesized for each satellite, one of which should be the true integer ambiguity. The index on the vector hypothesis is denoted as θ. Clearly, this assumption is based on a reasonable size search space of hypotheses and a generally good quality initial condition. Using the estimated variance of the error in the initial integer, a good search space would look for integers within a three-sigmas of the assumed error variance of each satellite. When combined with all visible satellites, a search space of +/−m integers for n satellites will require n^{2m+1} vectors to be tested.

For each hypothesized vector ΔΔ N̅_{θ} the following residual is formed using both the geometry free residual and the annihilated residual. This total residual, if the hypothesis θ is correct, has the noise characteristics as shown. However, if the hypothesis is not correct, then the residual should be biased in the direction of the incorrect hypothesis. A total of n^{2m+1} residuals are calculated.

$$\begin{matrix}{r}_{H} = [ \begin{matrix}{λ}_{WL} ( {ΔΔ}_{AB} {\tilde{φ}}_{WL} + {ΔΔ}_{AB} {\overline{N}}_{WL} + ΔΔ {\overline{N}}_{θ} ) - {ΔΔ}_{AB} {\tilde{ρ}}_{NL} \\ D [ {λ}_{WL} ( {ΔΔ}_{AB} {\tilde{φ}}_{WL} + {ΔΔ}_{AB} {\overline{N}}_{WL} + ΔΔ {\overline{N}}_{θ} ) - {ΔΔ}_{AB} \overline{ρ} ]\end{matrix} ] \\ = [ \begin{matrix}{ΔΔ}_{AB} {υ}_{WL}^{Ai} + {ΔΔ}_{AB} {η}_{NL}^{Ai} \\ D ( {ΔΔ}_{AB} {υ}_{WL}^{A} )\end{matrix} ]\end{matrix} \qquad ( 37 )$$

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

### DEFINITIONS

Recording the results from an operation or data acquisition, such as for example, recording results such as GPS observables, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

Processor means or microcomputer is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers, including data processors, are useful for controlling instrumentation, recording data and signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method of locating a first GPS receiver relative to a second GPS receiver, comprising the steps of:
providing a first GPS receiver and a second GPS receiver, each GPS receiver having its own GPS antenna, said first GPS receiver and said second GPS receiver spaced apart by a distance D along a baseline, said distance D to be determined;
receiving a finite number of observables on each of said first GPS receiver and said second GPS receiver from a plurality of GPS satellites in a finite period of time;
performing in a batch mode the following series of calculations on said finite number of observables:
calculating a least squares estimate position for each of said first GPS receiver and said second GPS receiver;
calculating a plurality of single difference residuals based on said observables;
calculating a plurality of double difference residuals based on said plurality of single difference residuals;
calculating an estimate of a geometry free solution;
applying geometric annihilation to said geometry free solution; and
calculating a least squares solution to provide a measurement of said distance D; and
performing a step selected from the steps consisting of recording the distance D, reporting the distance D to a user, and providing the distance D to another process that uses the distance D.

2. The method of claim 1, wherein said step of calculating a least squares solution includes an absolute position of at least one of said first GPS receiver and said second GPS receiver relative to said plurality of GPS satellites.

3. The method of claim 1, wherein said step of receiving observables comprises receiving a plurality of GPS L1, P1 and GPS L2, P2 data.

4. The method of claim 3, wherein said step of receiving observables further comprises computing at least one combination selected from the group of combinations consisting of a PC combination, a LC combination, a LWL combination, and a PNL combination from said plurality of L1, P1 and L2, P2 data.

5. The method of claim 1, wherein said step of receiving observables comprises receiving observables in a GPS RINEX format.

6. The method of claim 1, further comprising, after said step of receiving observables and before said step of calculating a least squares estimate position, a step of processing said residuals to remove outlying data which exceeds a bound value.

7. The method of claim 1, further comprising, after said step of receiving observables and before said step of calculating a least squares estimate position, a step of calculating corrections based on a measured or a modeled data of GPS radio propagation conditions of the Troposphere.

8. The method of claim 7, further comprising, calculating corrections using an annihilation technique with modeled data of GPS radio propagation conditions of the Troposphere.

9. The method of claim 1, wherein said step of calculating a plurality of single difference residuals comprises forming said single differences from at least a selected one of a LWL combination, a PNL combination, and a PC combination.

10. The method of claim 1, wherein said step of calculating a plurality of double difference residuals comprises forming said double differences from at least a selected one of a LWL combination, a PNL combination, and a PC combination.

11. The method of claim 1, wherein said step of calculating an estimate of a geometry free solution comprises an estimate of a double difference ambiguity using a LWL−PWL combination.

12. The method of claim 1, wherein said step of calculating an estimate of a geometry free solution comprises calculating an estimate and fix integer by averaging LWL−PNL over each arc length.

13. The method of claim 1, wherein said step of calculating an estimate of a geometry free solution comprises filtering and removing LWL+fix−PNL outlier estimates greater than a bound value.

14. A batch processing mode differential GPS apparatus, comprising:
a data processor configured to receive a plurality of GPS observables observed over a fixed time period from each of a first GPS receiver and a second GPS receiver, each GPS receiver having its own GPS antenna, said first GPS receiver and said second GPS receiver spaced apart by a distance D, said distance D to be determined, said data processor having instructions in machine-readable form recorded therein, said data processor configured to perform a process comprising the steps of:
receiving a finite number of observables on each of said first GPS receiver and said second GPS receiver from a plurality of GPS satellites in a finite period of time;
performing in a batch mode the following series of calculations on said finite number of observables:
calculating a least squares estimate position for each of said first GPS receiver and said second GPS receiver;
calculating a plurality of single difference residuals based on said observables;
calculating a plurality of double difference residuals based on said plurality of single difference residuals;
calculating an estimate of a geometry free solution;
applying geometric annihilation to said geometry free solution; and
calculating a least squares solution to obtain a result including said distance D between said first GPS receiver and said second GPS receiver when said instructions are operating; and
at least one device selected from the group of devices consisting of a recording device configured to record a distance result, a display device configured to display said distance result, and a communications device configured to provide said distance result to another device.

15. The batch processing mode differential GPS apparatus of claim 14, configured to perform said step of calculating a least squares solution which includes an absolute position of at least one of said first GPS receiver and said second GPS receiver relative to said plurality of GPS satellites.

16. The batch processing mode differential GPS apparatus of claim 14, configured to perform said step of receiving observables by receiving a plurality of GPS L1, P1 and GPS L2, P2 data.

17. The batch processing mode differential GPS apparatus of claim 14, configured to perform a step of computing at least one combination selected from the group of combinations consisting of a PC combination, a LC combination, a LWL combination, and a PNL combination from said plurality of L1, P1 and L2, P2 data.

18. The batch processing mode differential GPS apparatus of claim 14, configured to perform a step of processing said residuals to remove outlying data which exceeds a bound value after said step of receiving observables and before said step of calculating a least squares estimate position.

19. The batch processing mode differential GPS apparatus of claim 14, configured to perform a step of calculating corrections based on a measured or a modeled data of GPS radio propagation conditions of the Troposphere after said step of receiving observables and before said step of calculating a least squares estimate position.

20. The batch processing mode differential GPS apparatus of claim 19, configured to perform a step of calculating corrections using an annihilation technique with modeled data of GPS radio propagation conditions of the Troposphere.
